(19) United States
(12) Patent Application Publication
(10) Pub. No.: US 2015/0316310 A1
(43) Pub. Date: Nov. 5, 2015

(54) THERMAL ACCUMULATOR FOR A TRANSPORT REFRIGERATION SYSTEM

(71) Applicant: THERMO KING CORPORATION, Minneapolis, MN (US)

(72) Inventors: Pavel HOUDEK, Kutna Hora (CZ); Václav RAJTMAJER, Beroun (CZ); Michal KOLDA, Prague (CZ); Markéta KOPECKA, Prague (CZ); Michal HEGAR, Prague (CZ)

(73) Assignee: THERMO KING CORPORATION, Minneapolis, MN (US)

(21) Appl. No.: 14/268,239

(22) Filed: May 2, 2014

(51) Int. Cl. F25D 11/02; F28D 20/02; B23P 15/26

(52) U.S. Cl. CPC F25D 11/02; B23P 15/26; F28D 20/021

(57) ABSTRACT

A thermal accumulator, a thermal accumulator module, and a method for controlling refrigeration in a transport refrigeration system (TRS) are described. The thermal accumulator module includes a plurality of thermal accumulators. Each of the plurality of thermal accumulators includes a fluid tight housing configured for attachment in an internal space of a refrigerated transport unit. The housing is configured to withstand a load applied when installing the thermal accumulator module in the internal space. An aluminum compatible phase change material is contained within the housing in a first state and configured to absorb thermal energy from the internal space of the refrigerated transport unit during transformation to a second state. One or more faces of the housing include a heat transfer enhancer.

### FIELD

Embodiments of this disclosure relate generally to a transport refrigeration system (TRS). More specifically, the embodiments relate to a thermal accumulator having a phase change material (PCM) for use in a TRS.

### BACKGROUND

A transport refrigeration system (TRS) is generally used to control an environmental condition such as, but not limited to, temperature and/or humidity of a refrigerated container. Examples of refrigerated containers include, but are not limited to, a container on a flat car, an intermodal container, a truck, a boxcar, or other similar transport unit (generally referred to as a “refrigerated transport unit”). A refrigerated transport unit is commonly used to transport perishable items such as, but not limited to, produce, frozen foods, and meat products. Generally, the refrigerated transport unit includes a transport refrigeration unit (TRU) that is attached to the transport unit to control the environmental condition of a cargo space. The TRU can include, without limitation, a compressor, a condenser, an expansion valve, an evaporator, and fans or blowers to control the heat exchange between the air inside the cargo space and the ambient air outside of the refrigerated transport unit.

### SUMMARY

Embodiments of this disclosure relate generally to a transport refrigeration system (TRS). More specifically, the embodiments relate to a thermal accumulator having a phase change material (PCM) for use in a TRS.

In some embodiments, a refrigerated transport unit can include a thermal accumulator. In some embodiments, a refrigerated transport unit can include a thermal accumulator module.

In some embodiments, a thermal accumulator can be removably affixed to a wall or a ceiling of an internal space of a refrigerated transport unit. In some embodiments, a thermal accumulator module can be removably affixed to a wall or a ceiling of the internal space of the refrigerated transport unit. In some embodiments, a thermal accumulator can be removably affixed to a wall or a ceiling and a thermal accumulator module can be affixed to a wall or ceiling of the internal space of the refrigerated transport unit.

A thermal accumulator or a thermal accumulator module can be removably affixed to a wall or a ceiling of a refrigerated transport unit before cargo is loaded into the refrigerated unit. In other embodiments, the thermal accumulator or thermal accumulator module can be removably affixed to a wall or a ceiling of the refrigerated transport unit after cargo is loaded into the refrigerated transport unit.

In some embodiments, a TRS can include a thermal accumulator and/or a thermal accumulator module in place of a TRU. In other embodiments, the thermal accumulator and/or thermal accumulator module can be installed in addition to a TRU.

In some embodiments, a capacity of a TRS employing a thermal accumulator can be controlled by altering the number of thermal accumulators included in an internal space of the refrigerated transport unit.

An operating temperature of a TRS employing a thermal accumulator can be controlled by altering the number of thermal accumulators included in an internal space, according to some embodiments. The operating temperature can also be controlled by altering the type of PCM contained within the thermal accumulator. In some embodiments, the operating temperature can be controlled by altering the number of thermal accumulators in the internal space or the type of PCM contained within the thermal accumulator. In other embodiments, the operating temperature can be controlled by altering the number of thermal accumulators in the internal space and the type of PCM contained within the thermal accumulator.

In some embodiments, an aluminum compatible phase change material (PCM) includes a solution of hydrogen peroxide (H₂O₂). The concentration of hydrogen peroxide can vary according to, for example, a desired phase change temperature for the PCM. In some embodiments, the concentration of hydrogen peroxide can range from about 1% to about 35%. It is to be appreciated that this range is exemplary and that the concentration of hydrogen peroxide can vary beyond the stated ranges. In some embodiments, the aluminum compatible PCM can include a solution of propylene glycol (C₃H₈O₂). The concentration of propylene glycol can vary according to, for example, a desired phase change temperature for the PCM. In some embodiments, the concentration of propylene glycol can, for example, be about 50%. In some embodiments, the aluminum compatible PCM can be a commercially available PCM, such as, but not limited to, PureTemp-37 (sold by Entropy Solutions, Inc.), PlusICE E-34 (sold by PCM Products Limited), and the like.

In some embodiments, the PCM can be selected based upon its phase change temperature. Generally, the phase change temperature for a PCM in a thermal accumulator configured for use in a refrigerated transport unit can range from about −40° C. to about 15° C. It is to be appreciated that this temperature range is exemplary and that the temperatures can vary beyond the stated range.

In some embodiments, the PCM can be a eutectic solution. In other embodiments, the PCM can be a non-eutectic solution. A refrigerated transport unit includes an internal space configured to have a controlled environmental condition such as, but not limited to, temperature and/or humidity. In some embodiments, a TRS can include a thermal accumulator. In some embodiments, the TRS can include a plurality of thermal accumulators. In other embodiments, the TRS can include a thermal accumulator module which includes a plurality of thermal accumulators. In some embodiments, the TRS can include a plurality of thermal accumulator modules.

A thermal accumulator for use in a TRS is described. The thermal accumulator includes a fluid tight housing configured for attachment in an internal space of a refrigerated transport unit. The housing is configured to withstand a load applied when installing the thermal accumulator in the internal space. An aluminum compatible phase change material is contained within the housing in a first state and configured to absorb thermal energy from the internal space of the refrigerated transport unit during transformation to a second state. One or more faces of the housing include a heat transfer enhancer configured to increase transfer of thermal energy from the internal space.

A thermal accumulator module for use in a TRS is described. The thermal accumulator module includes a plurality of thermal accumulators. Each of the plurality of thermal accumulators includes a fluid tight housing configured for attachment in an internal space of a refrigerated transport unit. The housing is configured to withstand a load applied when installing the thermal accumulator module in the internal space. An aluminum compatible phase change material is contained within the housing in a first state and configured to absorb thermal energy from the internal space of the refrigerated transport unit during transformation to a second state. One or more faces of the housing include a heat transfer enhancer configured to increase transfer of thermal energy from the internal space.

A method of controlling refrigeration in a transport refrigeration system (TRS) for a refrigerated transport unit, the transport unit including an internal space is described. The method includes providing a first thermal accumulator including a fluid tight housing configured for attachment in the internal space of the refrigerated transport unit. The housing is configured to withstand a load applied when installing the thermal accumulator in the internal space. An aluminum compatible phase change material is contained within the housing in a first state and configured to absorb thermal energy from the internal space of the refrigerated transport unit during transformation to a second state. One or more faces of the housing include a heat transfer enhancer.

### Comments

The following is noted with respect to the embodiments described herein.

The thermal accumulator discussed herein can include a PCM that is adaptable to heat or to cool a storage space (e.g., a cargo compartment) to a temperature suitable for the cargo stored in the storage space. The thermal accumulator can also be used for a defrost operation within the storage space.

Operation of the TRS for a refrigerated transport unit can be independent to various thermal loads that occur due to external conditions external the refrigerated transport unit. That is, the thermal accumulator of the TRS can maintain a desired temperature within the storage space of the refrigerated transport unit regardless of external conditions outside of the refrigerated transport unit.

The PCM used in the thermal accumulator can be any fluid which has a solid-liquid transition point in a rage between about −32° C. and about 0° C. The PCM can be compatible with metals, for example, aluminum. The PCM can store heat in a transition phase using a latent heat (e.g., heat of fusion). The PCM can store heat in a liquid phase. The PCM can have a phase transition temperature that absorbs changes in temperature of the refrigerated transport unit.

The thermal accumulator allows a transfer of heat from the PCM to an air space within the storage space and vice versa. The heat exchanger can include a single, dual, or multiple pass design. The thermal accumulator can use a natural or forced convection to facilitate heat exchange between the PCM and an air space within the storage space. In some embodiments, the thermal accumulator can include a wall or walls with a substantially flat surface and a wall or walls with at least a partially enhanced (e.g., ribbed surface). The thermal accumulator can store a PCM and/or include an empty or free expansion space within the thermal accumulator.

In some embodiments, a thermal accumulator compartment storing a thermal accumulator can be retrofitted into/onto a refrigerated transport unit. The thermal accumulator compartment can be installed to the refrigerated transport unit without specialized equipment. In some embodiments, the thermal accumulator compartment can be designed such that the weight of the thermal accumulator compartment can be supported by a floor, one or more side walls, or a ceiling of the refrigerated transport unit. In some embodiments, the PCM can be provided in the thermal accumulator from the top.

The TRS can provide a defrost operation. In some embodiments, a second fluid or refrigerant may be used to perform a defrost operation. In some embodiments, the TRS can include an optional defrost device (e.g., heating bar(s), heating sheet(s), heating tube(s), etc.) for performing the defrost operation. In some embodiments, the thermal accumulator can include a second fluid or refrigerant line to perform the defrost operation. In some embodiments, the defrost operation can be performed in less than 24 hours.

In some embodiments, the TRS can include one or more fans. The power of the fans can be adjusted based on a temperature within the storage space. The fans can provide an air flow rate sufficient to reach a desired amount of heat transfer from the PCM in the thermal accumulator to an air space within the storage space and vice versa. The fans can be controlled/adjusted based on a desired set point temperature within the storage space.

### BRIEF DESCRIPTION OF THE DRAWINGS

References are made to the accompanying drawings that form a part of this disclosure and which illustrate the embodiments in which the systems and methods described in this Specification can be practiced.

FIG. 1 illustrates a transport refrigeration system (TRS) for a refrigerated transport unit, according to some embodiments.

FIG. 2A illustrates a thermal accumulator, according to some embodiments.

FIG. 2B illustrates a thermal accumulator, according to other embodiments.

FIG. 3 illustrates a thermal accumulator module, according to some embodiments.

Like reference numbers represent like parts throughout.

### DETAILED DESCRIPTION

Embodiments of this disclosure relate generally to a transport refrigeration system (TRS). More specifically, the embodiments relate to a thermal accumulator having a phase change material (PCM) for use in a TRS.

A TRS is generally used to control an environmental condition such as, but not limited to, temperature, humidity, and air quality of a refrigerated transport unit. Examples of refrigerated transport units include, but are not limited to, a container on a flat car, an intermodal container, a truck, a boxcar, or other similar transport unit (generally referred to as a “refrigerated transport unit”). A refrigerated transport unit can be used to transport perishable items such as, but not limited to, produce, frozen foods, and meat products.

As disclosed in this specification, a TRS can include a transport refrigeration unit (TRU) which is attached to a transport unit to control the environmental condition (e.g., temperature, humidity, air quality, etc.) of an interior space of the refrigerated transport unit. The TRU can include, without limitation, a compressor, a condenser, an expansion valve, an evaporator, and fans or blowers to control the heat exchange between the air within the interior space and the ambient air outside of the refrigerated transport unit. The TRS can additionally include one or more thermal accumulators and/or thermal accumulator modules containing a PCM. In such systems, the thermal accumulator may allow the TRU to be disabled for a period of time while still maintaining the desired environmental condition. In some TRSs, the TRU can be removed and the environmental condition can be controlled using the thermal accumulator. However, in such systems, the PCM in the thermal accumulator can require recharging, which causes a period of time in which the refrigerated transport unit is stopped in order for the PCM to be returned to the appropriate temperature.

Embodiments described in this specification include thermal accumulators and thermal accumulator modules having a PCM contained therein. The thermal accumulators and thermal accumulator modules are replaceable and rechargeable outside of the refrigerated transport unit. In some embodiments, this can reduce an amount of time in which the refrigerated transport unit is idle. In some embodiments, this can reduce the weight of the refrigerated transport unit as a TRU may not be part of the system.

A “transport unit” includes, for example, a container on a flat car, an intermodal container, truck, a boxcar, or other similar transport unit.

A “transport refrigeration system” (TRS) includes, for example, a refrigeration system for controlling the refrigeration of an interior space of a refrigerated transport unit. The TRS may be a vapor-compressor type refrigeration system, a thermal accumulator type system, or any other suitable refrigeration system that can use refrigerant, cold plate technology, or the like.

A “refrigerated transport unit” includes, for example, a transport unit having a TRS.

A “phase change material” (PCM) includes, for example, a material that can store or release a large amount of energy upon a phase change (e.g., from a solid to a liquid, a liquid to a solid, etc.) while remaining at about a constant temperature. A PCM can gradually absorb heat (e.g., from an interior space of a refrigerated transport unit, etc.) while remaining at about a constant temperature during a phase transformation from a solid state into a liquid state. A PCM can, for example, be used to maintain an interior space of a refrigerated transport unit at a desired temperature.

A “eutectic PCM” includes, for example, a PCM that solidifies at a lower temperature than any other compositions made of the same ingredients.

An “aluminum compatible PCM” includes, for example, a PCM that is not corrosive to aluminum. Examples of aluminum compatible PCMs include, but are not limited to, a mixture of hydrogen peroxide and water, a propylene glycol and water mixture, and the like.

Embodiments of this disclosure may be used in any suitable environmentally controlled transport apparatus, such as, but not limited to, a shipboard container, an air cargo cabin, and an over the road truck cabin. The TRS can be a vapor-compressor type refrigeration system or any other suitable refrigeration system that can use refrigerant, cold plate technology, or the like.

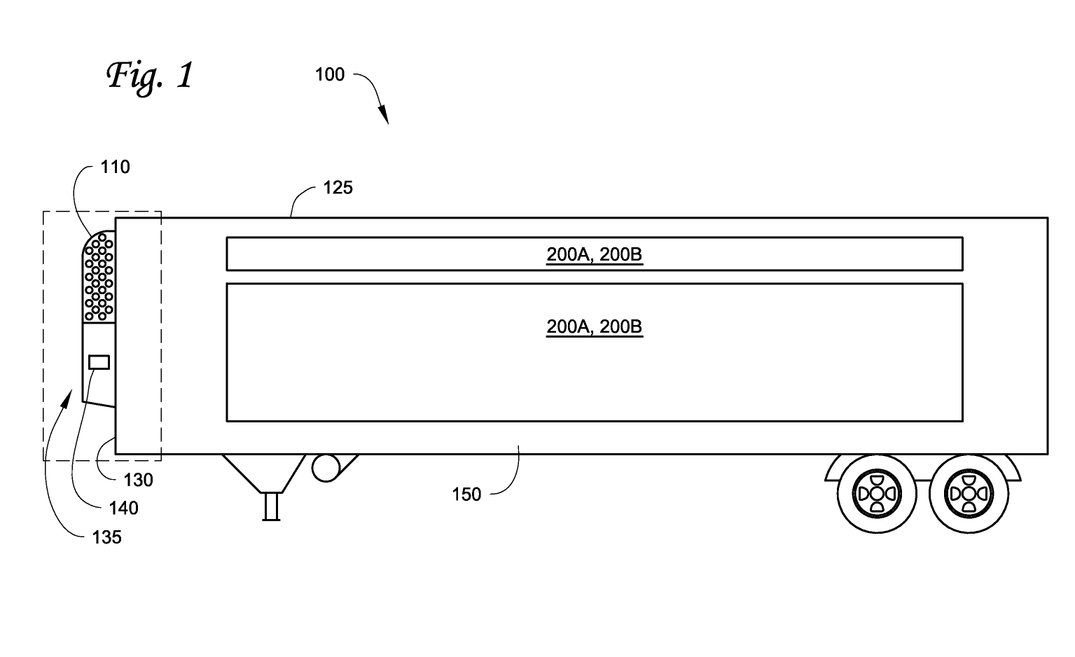

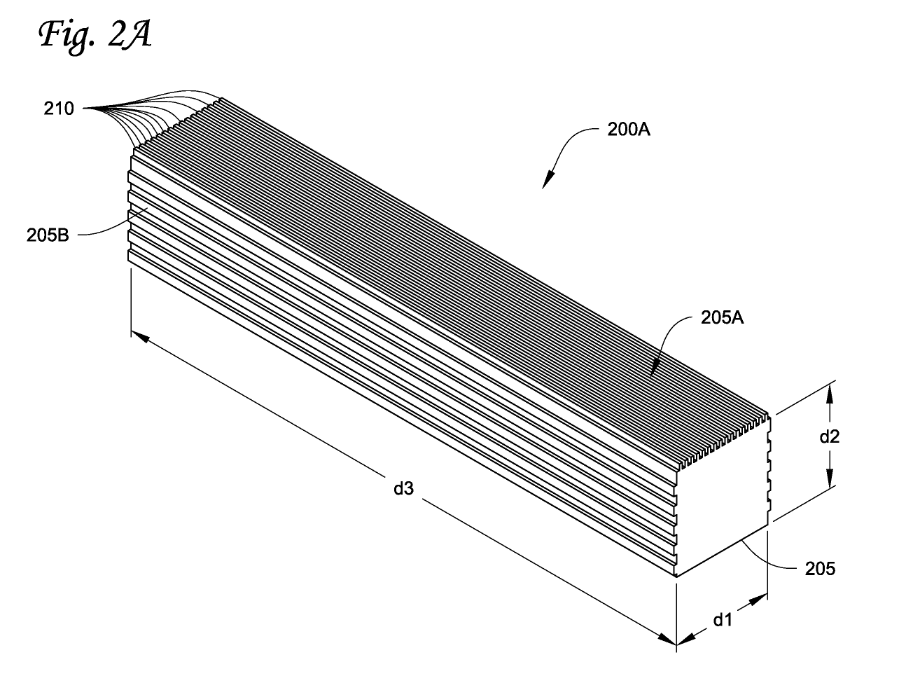

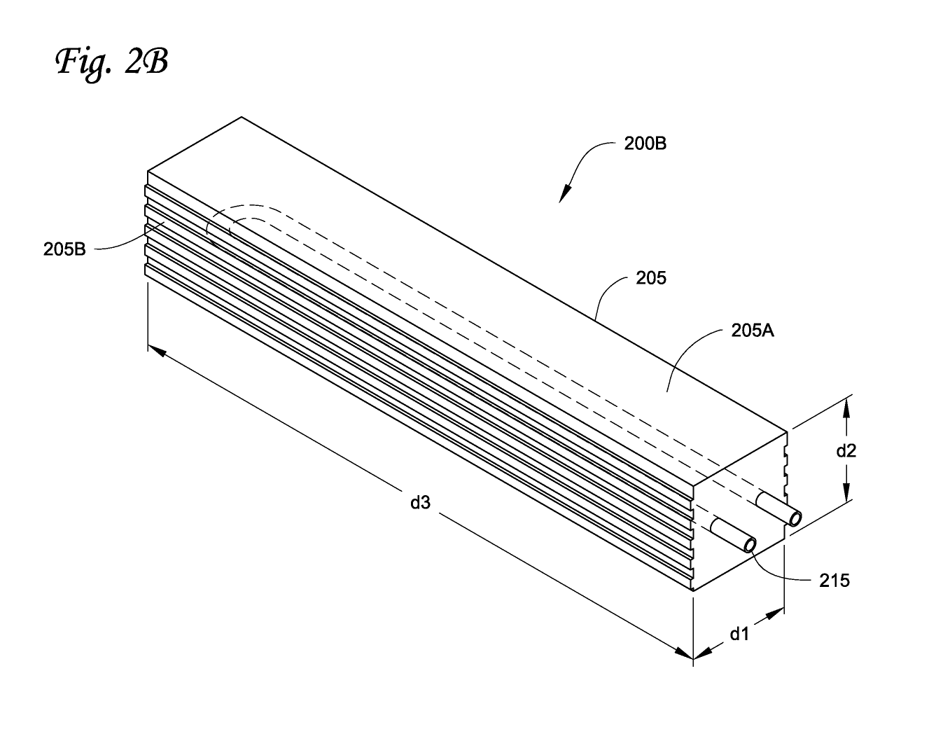

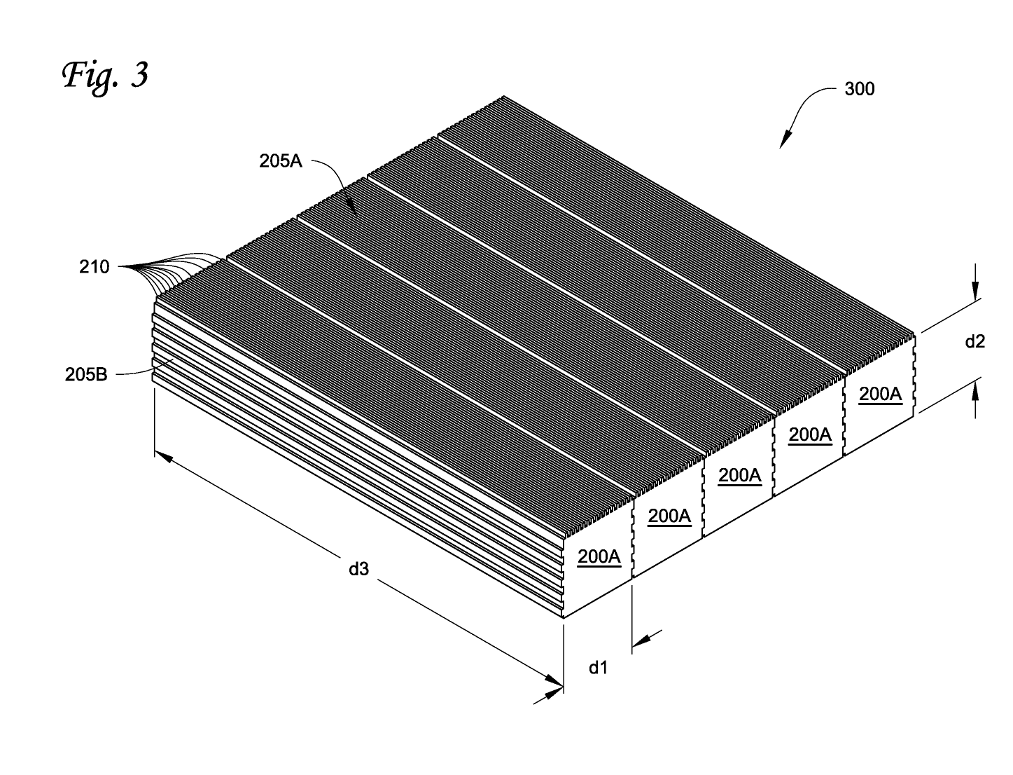

FIG. 1 illustrates a TRS 100 for a refrigerated transport unit 125, according to some embodiments. The TRS 100 includes one or more thermal accumulators 200A, 200B that control refrigeration within the refrigerated transport unit 125. The one or more thermal accumulators 200A, 200B can be disposed on a ceiling of the refrigerated transport unit 125 in some embodiments. In other embodiments, the one or more thermal accumulators 200A, 200B can be disposed on one or more walls of the refrigerated transport unit 125. In some embodiments, the one or more thermal accumulators 200A, 200B can be disposed on both the ceiling and one or more walls of the refrigerated transport unit 125. It is to be appreciated that the one or more thermal accumulators 200A, 200B can alternatively be one or more thermal accumulator modules 300. The one or more thermal accumulators 200A, 200B and the thermal accumulator modules 300 are discussed in additional detail in accordance with FIGS. 2A-3 below.

The refrigerated transport unit 125 includes an interior space 150. The interior space 150 can be divided into a plurality of zones, according to some embodiments. It is to be appreciated that the interior space 150 may be divided into any number of zones and in any configuration that is suitable for refrigeration of the different zones. In some examples, each of the zones can have a set point temperature that is the same or different from one another, and may be separated by a wall/partition (not shown). Examples of refrigerated transport units include, but are not limited to, a truck or trailer unit that can be attached to a tractor, a ship board container, an air cargo container or cabin, an over the road truck cabin, or the like.

The refrigeration within the refrigerated transport unit 125 can be controlled using the one or more thermal accumulators 200A, 200B. The one or more thermal accumulators 200A, 200B can include a heat exchanger (e.g., heat exchanger 215 disposed within thermal accumulator 200B, which is described in additional detail in accordance with FIG. 2B below). It is to be appreciated that the one or more thermal accumulators 200A, 200B do not require a heat exchanger (e.g., thermal accumulators 200A described in additional detail in accordance with FIG. 2A below). The one or more thermal accumulators 200A, 200B can be removable and/or replaceable in order to allow for charging of the one or more thermal accumulators 200A, 200B outside the refrigerated transport unit 125. Because a TRU 110 is not required, the weight of the refrigerated transport unit 125 can be reduced from a refrigerated transport unit 125 including the TRU 110. In some embodiments, this may improve a fuel efficiency of a vehicle pulling the refrigerated transport unit 125.

In some embodiments, the TRU 110 can be included in conjunction with the one or more thermal accumulators 200A, 200B. In such embodiments, the TRU 110 can be disposed on a front wall 130 of the refrigerated transport unit 125. The TRU 110 includes a programmable TRS Controller 135 that may include a single integrated control unit 140 or that may include a distributed network of TRS control elements (not shown). The number of distributed control elements in a given network can depend upon the particular application of the principles described in this specification.

The TRS controller 135 can include a processor, a memory, a clock, and an input/output (I/O) interface (not shown). The TRS controller 135 can include fewer or additional components. The TRS controller can be configured to enable/disable the TRU 110 to, for example, keep a PCM contained in a thermal accumulator within an on-phase temperature operating range and/or at a first state temperature.

Generally, the TRS Controller 135 is configured to control a heat transfer cycle of the TRS 100. In one example, the TRS Controller 135 controls the heat transfer cycle of the TRS 100 to obtain various operating conditions (e.g., temperature, humidity, air quality etc.) of the interior space 150. In some embodiments, this can include maintaining a PCM disposed within the one or more thermal accumulators 200A, 200B at or near the PCM's corresponding phase change temperature at which the PCM changes from a first state to a second state. In other embodiments, this can include charging the one or more thermal accumulators 200A, 200B and then operating the TRS 100 without running the TRU 110. In other embodiments, the one or more thermal accumulators 200A, 200B can be charged and then maintained at or near the PCM's corresponding phase change temperature.

The TRU 110 is not required to be disposed on the refrigerated transport unit 125, according to some embodiments. In such embodiments, the refrigeration can be controlled by the one or more thermal accumulators 200A, 200B. The TRU 110 can, for example, be a portable unit that is configured to be connected in communication with the internal space 150 of the refrigerated transport unit 125. In other embodiments, the TRU 110 may be not be portable, but may be connectable to charge the one or more thermal accumulators 200A, 200B. In such embodiments, the TRU 110 can be connected in fluid communication with the heat exchanger of the one or more thermal accumulators 200A, 200B. Alternatively, the TRU can be connected in fluid communication with the internal space 150 and provide a refrigerated air to charge the one or more thermal accumulators 200A, 200B.

FIG. 2A illustrates a thermal accumulator 200A, according to some embodiments. The thermal accumulator 200A can be installed in a refrigerated transport unit (e.g., the refrigerated transport unit 125 of FIG. 1). The thermal accumulator 200A is generally configured to contain a PCM suitable for accumulating thermal energy in an interior space (e.g., the interior space 150 of FIG. 1) of the refrigerated transport unit 125.

The thermal accumulator 200A includes a housing 205. The housing is generally cuboidal having a width d1, a height d2, and a length d3. Geometries other than cuboidal are contemplated. The housing 205 can be made of aluminum or other metals having similar heat transfer properties. In some embodiments, the housing 205 can be plastic. The material selected for the housing 205 is sufficiently rigid to be clamped into the refrigerated transport unit 125 without damaging the thermal accumulator 200A and such that the PCM does not leak from the thermal accumulator 200A when it is installed in the refrigerated transport unit 125. The housing 205 can be manufactured using an extrusion process, according to some embodiments.

The housing 205 includes at least one face 205A having a plurality of fins 210. In some embodiments, the plurality of fins 210 can be another type of heat transfer enhancer similar to a fin. In some embodiments, the housing 205 can have fins 210 on a plurality of faces. The fins 210 are configured and arranged to increase the surface area of the thermal accumulator 200A, thereby increasing the rate of heat transfer between the interior space 150 and the thermal accumulator 200A.

The housing 205 is configured such that a PCM (not shown) is disposed within the housing 205. Accordingly, the housing 205 is fluid tight to maintain the PCM within the housing 205. The PCM disposed within the housing 205 is generally an aluminum compatible PCM in order to prevent corrosive effects of the PCM from deteriorating the housing 205. In some embodiments, this can extend the lifetime of the thermal accumulator 200A. In some embodiments, the aluminum compatible PCM may have a reduced adverse impact on the environment.

In some embodiments, the PCM contained within the housing 205 can include a mixture having hydrogen peroxide (H₂O₂). Suitable mixtures include solutions having between about 1 percent hydrogen peroxide and about 35 percent hydrogen peroxide. In some embodiments, the hydrogen peroxide can be mixed with distilled water. In other embodiments, the PCM contained within the housing 205 can include a mixture having between about 1 percent and about 50 percent propylene glycol. In some embodiments, the PCM can be a commercially available PCM, such as PureTemp −37 (sold by Entropy Solutions, Inc.) or PlusICE E-34 (sold by PCM Products Limited). In some embodiments, the PCM is a eutectic solution, while in other embodiments the PCM is a non-eutectic solution.

The housing 205 includes a face 205B with one or more grooves or channels suitable for joining two or more thermal accumulators 200A into a thermal accumulator module (e.g., thermal accumulator module 300 as described in accordance with FIG. 3 below). In some embodiments, the grooves or channels can facilitate the mating of two or more thermal accumulators 200A. In some embodiments, the housing 205B can include a plurality of faces 205B having similar configurations. In such embodiments, the faces 205B can be in communication with faces of similar thermal accumulators on both sides, or on just one side. In some embodiments, the face 205B can be flat/smooth.

The thermal accumulator 200A is generally configured to be removable and replaceable from the refrigerated transport unit 125. Further, the thermal accumulator 200A is designed such that it can be installed and removed from a variety of refrigerated transport units. That is, the thermal accumulator 200A can be installed in a trailer type refrigerated transport unit, removed, and installed in a boxcar, intermodal container, or the like. As a result, the same thermal accumulator 200A can be used in many different applications, without having to purchase thermal accumulators specific to a particular application. Alternatively, in some embodiments, the thermal accumulator 200A can be designed such that it is application specific and used only in a specific type of refrigerated transport unit, though the thermal accumulator 200A in such an embodiment can still be removed and installed into a different refrigerated transport unit of the same or a similar type and configuration.

The thermal accumulator 200A can be installed on a wall or the ceiling of the refrigerated transport unit 125. In some embodiments, a plurality of thermal accumulators 200A can be installed on a wall or the ceiling of the refrigerated transport unit 125. The desired set point temperature, the duration of transport, or the like, can be considered when determining how many thermal accumulators 200A to install and what type of PCM is to be contained therein. The installation process can be manual or can be automated using suitable equipment and machinery. In some embodiments, the thermal accumulator 200A can be installed prior to loading the refrigerated transport unit 125 with cargo, while in other embodiments the thermal accumulator 200A can be installed after the refrigerated transport unit 125 is already loaded.

The thermal accumulator 200A is charged prior to installation in the refrigerated transport unit 125. After the thermal accumulator 200A has been used and is no longer in its solid state, the thermal accumulator 200A can be removed from the refrigerated transport unit 125 in order to be charged back to its solid state. In some embodiments, the thermal accumulator 200A can be charged in a refrigerated room that is maintained at an appropriate temperature depending on the solid-state temperature of the PCM contained in the thermal accumulator 200A. In some embodiments, charging can include adding or removing thermal energy. Once charged, the thermal accumulator 200A can be installed in the refrigerated transport unit 125 or any other suitable refrigerated transport unit. The plurality of fins 210 are not illustrated on the face 205A of the thermal accumulator 200B in order to show the heat exchanger 215.

FIG. 2B illustrates a thermal accumulator 200B, according to other embodiments. Aspects of the thermal accumulator 200B can be the same as, or similar to, aspects of the thermal accumulator 200A of FIG. 2A.

The thermal accumulator 200B further includes a heat exchanger 215. The heat exchanger 215 can be used to charge the PCM contained within the housing 205 of the thermal accumulator 200B. The heat exchanger 215 is generally used to decrease an amount of time required to charge the thermal accumulator 200B to its solid state. Accordingly, the thermal accumulator 200B can be faster to charge than the thermal accumulator 200A. In some embodiments, even though the heat exchanger 215 is present, it may not be used when charging the thermal accumulator 200B. In such embodiments, the thermal accumulator 200B can be charged in a manner that is the same as or similar to the manner described above for charging the thermal accumulator 200A.

The thermal accumulator 200B can be connected to a refrigerant circuit (not shown) when being charged outside of a refrigerated transport unit (e.g., the refrigerated transport unit 125 of FIG. 1). In some embodiments, the thermal accumulator 200B can be connected to a refrigerant circuit that is part of the refrigerated transport unit 125. The refrigerant circuit can include a refrigerant, according to some embodiments. In other embodiments, the refrigerant can include a chilled water or mixture including water. In some embodiments, the heat exchanger 215 includes an expansion valve disposed at an end of the heat exchanger 215. In some embodiments, the expansion valve can be disposed within the housing 205 of the thermal accumulator 200B. In other embodiments, the expansion valve is disposed outside the housing 205 of the thermal accumulator 200B. In some embodiments, the heat exchanger 215 does not include the expansion valve.

FIG. 3 illustrates a thermal accumulator module 300, according to some embodiments. As illustrated, the thermal accumulator module 300 includes five of the thermal accumulators 200A attached to form the thermal accumulator module 300. The number of thermal accumulators can vary depending on a particular application. Accordingly, the number of thermal accumulators 200A in the thermal accumulator module 300 can be less than or equal to five in some embodiments and greater than five in other embodiments. The thermal accumulator module 300 can alternatively include a plurality of thermal accumulators 200B as shown in FIG. 2B. In such an embodiment, the plurality of thermal accumulators 200B can each include the heat exchanger 215. The thermal accumulator module 300 can be charged to its solid state using a similar approach as that described above with reference to the thermal accumulator 200A and the thermal accumulator 200B.

In some embodiments, the heat exchangers 215 from the plurality of thermal accumulators 200B can be connected in communication with a single refrigeration circuit.

Alternatively, the heat exchangers 215 from the plurality of thermal accumulators 200B can be connected in communication with a plurality of refrigeration circuits.

### ASPECTS

It is noted that any of aspects 1-8 can be combined in any combination with any of aspects 9-17 or 18-26. Further, any of aspects 9-17 or 18-26 can be combined in any combination.

Aspect 1. A thermal accumulator for use in a transport refrigeration system (TRS), comprising:
a fluid tight housing configured to be removably fixed in an internal space of a refrigerated transport unit, wherein the housing is configured to withstand a load applied when installing the thermal accumulator in the internal space; and
an aluminum compatible phase change material contained within the housing in a first state and configured to absorb thermal energy from the internal space of the refrigerated transport unit during transformation to a second state,
wherein one or more faces of the housing include a heat transfer enhancer.

Aspect 2. The thermal accumulator according to aspect 1, further comprising:
a conduit configured for use as a heat exchanger having at least a portion disposed within the housing.

Aspect 3. The thermal accumulator according to aspect 2, further comprising: an expansion valve disposed in an external portion of the conduit.

Aspect 4. The thermal accumulator according to any of aspects 1-3, wherein the housing is cuboidal.

Aspect 5. The thermal accumulator according to any of aspects 1-4, wherein the housing is made of aluminum.

Aspect 6. The thermal accumulator according to any of aspects 1-5, wherein the housing is produced by an extrusion process.

Aspect 7. The thermal accumulator according to any of aspects 1-6, wherein the aluminum compatible phase change material includes one of a hydrogen peroxide mixture and a propylene glycol mixture.

Aspect 8. The thermal accumulator according to any of aspects 1-7, wherein the heat transfer enhancer includes one or more fins.

Aspect 9. A thermal accumulator module for use in a transport refrigeration system (TRS), comprising:
a plurality of thermal accumulators, wherein each of the plurality of thermal accumulators comprises:
a fluid tight housing configured for attachment in an internal space of a refrigerated transport unit, wherein the housing is configured to withstand a load applied when installing the thermal accumulator module in the internal space; and
an aluminum compatible phase change material contained within the housing in a first state and configured to absorb thermal energy from the internal space of the refrigerated transport unit during transformation to a second state,
wherein one or more faces of the housing include a heat transfer enhancer.

Aspect 10. The thermal accumulator module according to aspect 9, wherein each of the plurality of thermal accumulators is the same.

Aspect 11. The thermal accumulator module according to any of aspects 9-10, wherein one of the plurality of thermal accumulators includes a conduit configured for use as a heat exchanger having at least a portion disposed within the housing.

Aspect 12. The thermal accumulator module according to any of aspects 9-11, wherein the housing is cuboidal.

Aspect 13. The thermal accumulator module according to any of aspects 9-12, wherein the housing is made of aluminum.

Aspect 14. The thermal accumulator module according to any of aspects 9-13, wherein the housing is produced by an extrusion process.

Aspect 15. The thermal accumulator module according to any of aspects 9-14, wherein the aluminum compatible phase change material includes one of a hydrogen peroxide mixture and a propylene glycol mixture.

Aspect 16. The thermal accumulator module according to any of aspects 9-15, wherein a first of the plurality of thermal accumulators includes a face having a channel to facilitate mating of the first of the plurality of thermal accumulators with a second of the plurality of thermal accumulators.

Aspect 17. The thermal accumulator module according to any of aspects 9-16, wherein the heat transfer enhancer includes one or more fins.

Aspect 18. A method of controlling refrigeration in a transport refrigeration system (TRS) for a refrigerated transport unit, the transport unit including an internal space, the method comprising:

providing a first thermal accumulator including a fluid tight housing configured for attachment in the internal space of the refrigerated transport unit, wherein the housing is configured to withstand a load applied when installing the thermal accumulator in the internal space, and an aluminum compatible phase change material contained within the housing in a first state and configured to absorb thermal energy from the internal space of the refrigerated transport unit during transformation to a second state, and one or more faces of the housing include a heat transfer enhancer.

Aspect 19. The method according to aspect 18, further comprising adding a second thermal accumulator to the internal space, the second thermal accumulator including a fluid tight housing configured for attachment in the internal space of the refrigerated transport unit, wherein the housing is configured to withstand a load applied when installing the thermal accumulator in the internal space, and an aluminum compatible phase change material contained within the housing in a first state and configured to absorb thermal energy from the internal space of the refrigerated transport unit during transformation to a second state, and one or more faces of the housing include a heat transfer enhancer.

Aspect 20. The method according to aspect 19, further comprising removing the first thermal accumulator from the internal space and adding the second thermal accumulator to the location from which the first thermal accumulator was removed.

Aspect 21. The method according to aspect 20, wherein the first thermal accumulator is removed from the internal space when the aluminum compatible phase change material contained within the housing of the first thermal accumulator has changed from the first state.

Aspect 22. The method according to any of aspects 20-21, wherein the first thermal accumulator is configured to control the internal space to a first operating temperature and the second thermal accumulator is configured to control the internal space to a second operating temperature.

Aspect 23. The method according to aspect 22, wherein the first operating temperature and the second operating temperature are different.

Aspect 24. The method according to any of aspects 19-23, wherein the first thermal accumulator and the second thermal accumulator are attached to form a single thermal accumulator module.

Aspect 25. The method according to any of aspects 20-24, further comprising:

after removing the first thermal accumulator from the internal space, charging the first thermal accumulator external to the internal space such that the aluminum compatible phase change material is in the first state.

Aspect 26. The method according to aspect 25, further comprising:

reattaching the first thermal accumulator to the internal space when the aluminum compatible phase change material is charged to the first state.

Aspect 27. The method according to aspect 19-26, further comprising:

removing the second thermal accumulator from the internal space when the aluminum compatible phase change material contained within the housing of the second thermal accumulator has changed from the first state.

The terminology used in this Specification is intended to describe particular embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. The word “embodiment” as used within this Specification may, but does not necessarily, refer to the same embodiment. This Specification and the embodiments described are exemplary only. Other and further embodiments may be devised without departing from the basic scope thereof, with the true scope and spirit of the disclosure being indicated by the claims that follow.

What is claimed is:

1. A method of controlling refrigeration in a transport refrigeration system (TRS) for a refrigerated transport unit, the transport unit including an internal space, the method comprising:
providing a first thermal accumulator including a fluid tight housing configured for attachment in the internal space of the refrigerated transport unit, wherein the housing is configured to withstand a load applied when installing the thermal accumulator in the internal space, and an aluminum compatible phase change material contained within the housing in a first state and configured to absorb thermal energy from the internal space of the refrigerated transport unit during transformation to a second state, and one or more faces of the housing include a heat transfer enhancer.

2. The method according to claim 1, further comprising:
adding a second thermal accumulator to the internal space, the second thermal accumulator including a fluid tight housing configured for attachment in the internal space of the refrigerated transport unit, wherein the housing is configured to withstand a load applied when installing the thermal accumulator in the internal space, and an aluminum compatible phase change material contained within the housing in a first state and configured to absorb thermal energy from the internal space of the refrigerated transport unit during transformation to a second state, and one or more faces of the housing include a heat transfer enhancer.

3. The method according to claim 2, further comprising:
removing the first thermal accumulator from the internal space and adding the second thermal accumulator to the location from which the first thermal accumulator was removed.

4. The method according to claim 3, wherein the first thermal accumulator is removed from the internal space when the aluminum compatible phase change material contained within the housing of the first thermal accumulator has changed from the first state.

5. The method according to claim 3, wherein the first thermal accumulator is configured to control the internal space to a first operating temperature and the second thermal accumulator is configured to control the internal space to a second operating temperature.

6. The method according to claim 5, wherein the first operating temperature and the second operating temperature are different.

7. The method according to claim 1, wherein the first thermal accumulator and the second thermal accumulator are attached to form a single thermal accumulator module.

8. The method according to claim 3, further comprising:
after removing the first thermal accumulator from the internal space, charging the first thermal accumulator external to the internal space such that the aluminum compatible phase change material is in the first state.

9. The method according to claim 8, further comprising:
reattaching the first thermal accumulator to the internal space when the aluminum compatible phase change material is charged to the first state.

10. The method according to claim 2, further comprising:
removing the second thermal accumulator from the internal space when the aluminum compatible phase change material contained within the housing of the second thermal accumulator has changed from the first state.

11. A thermal accumulator for use in a transport refrigeration system (TRS), comprising:
a fluid tight housing configured to be removably fixed in an internal space of a refrigerated transport unit, wherein the housing is configured to withstand a load applied when installing the thermal accumulator in the internal space; and
an aluminum compatible phase change material contained within the housing in a first state and configured to absorb thermal energy from the internal space of the refrigerated transport unit during transformation to a second state,
wherein one or more faces of the housing include a heat transfer enhancer.

12. The thermal accumulator according to claim 11, wherein the heat transfer enhancer includes one or more fins.

13. The thermal accumulator according to claim 11, further comprising:
a conduit configured for use as a heat exchanger having at least a portion disposed within the housing.

14. The thermal accumulator according to claim 13, further comprising:
an expansion valve disposed in an external portion of the conduit.

15. The thermal accumulator according to claim 11, wherein the housing is cuboidal.

16. The thermal accumulator according to claim 11, wherein the housing is made of aluminum.

17. The thermal accumulator according to claim 11, wherein the housing is produced by an extrusion process.
